(19) United States
(12) Patent Application Publication
(10) Pub. No.: US 2012/0295633 A1
(43) Pub. Date: Nov. 22, 2012

(54) USING USER'S SOCIAL CONNECTION AND INFORMATION IN WEB SEARCHING

(76) Inventors: Elad Yom-Tov, White Plains, NY (US); Fernando Diaz, Brooklyn, NY (US)

(21) Appl. No.: 13/111,656

(22) Filed: May 19, 2011

(51) Int. Cl. H04W 24/00

(52) U.S. Cl. 455/456.1

(57) ABSTRACT

The present disclosure relates to web searching, and more particularly to using a user's information, such as the user's geographic location, and social connections, such as geographic location of one or more friends of the user, in web searching, e.g., such as in filtering and/or ranking search results, identifying relevant queries, and/or identifying content, such as news items, for presentation on a web page presented to the user.

### FIELD OF THE DISCLOSURE

The present disclosure relates to web searching, and more particularly to using a user's information, such as the user's geographic location, and social connections, such as geographic location of one or more friends of the user, in web searching, e.g., such as in filtering and/or ranking search results, identifying relevant queries, and/or identifying content, such as news items, for presentation on a web page presented to the user.

### BACKGROUND

The web is a source of a vast amount of information made available by any number of providers. As one example, news providers that make news available in print, television and radio form at various levels, e.g., local, national and international levels, may make such news available via the web, e.g., the provider's web site. It is clear that other forms of information are also available via the web, and that more and more information will become available via the web over time.

Rather than visiting one or more specific web sites, a user typically performs a search of the web using a search engine to find information online via the web. A search engine provides a mechanism that allows a user to search for information using search criteria, e.g., key words or phrases. A search engine typically identifies multiple items of information, selects some number of the identified items using one or more criteria, e.g., relevance, and presents the selected items to the user. In many cases, the selected items are presented to the user in an order based on a ranking associated with each item, where the ranking can be based on the same or different criteria used to select the items.

It is important that web searching capabilities, such as might be provided by a search engine, be able to identify the information needs of users.

### SUMMARY

The present disclosure seeks to address failings in the art and to provide a method and system that identifies user information needs, and more particularly to provide a method and system of using user information and social networking information in web searching.

In accordance with one or more embodiments, a method is provided and comprises receiving, via at least one processor, a search request for a user; determining, via the at least one processor, a geographic separation measure for the user using a geographic location for the information sought in connection with the search request and a geographic location for the user; determining, via the at least one processor, a social affinity measure for the user, the social affinity measure being determined from the geographic location of each of one or more other users identified as having a social connection with the user and being within a threshold distance of the geographic location for the information sought; and generating, via the at least one processor, a response to the search request using the geographic separation and social affinity measures determined for the user.

In accordance with one or more embodiments, a system is provided, the system at least one computing device comprising one or more processors to execute and memory to store instructions to receive a search request for a user; determine a geographic separation measure for the user using a geographic location for the information sought in connection with the search request and a geographic location for the user; determine a social affinity measure for the user, the social affinity measure being determined from the geographic location of each of one or more other users identified as having a social connection with the user and being within a threshold distance of the geographic location for the information sought; and generate a response to the search request using the geographic separation and social affinity measures determined for the user.

In accordance with one or more embodiments, a computer readable non-transitory storage medium is provided, the computer readable non-transitory storage medium for tangibly storing thereon computer readable instructions that when executed cause at least one processor to receive a search request for a user; determine a geographic separation measure for the user using a geographic location for the information sought in connection with the search request and a geographic location for the user; determine a social affinity measure for the user, the social affinity measure being determined from the geographic location of each of one or more other users identified as having a social connection with the user and being within a threshold distance of the geographic location for the information sought; and generate a response to the search request using the geographic separation and social affinity measures determined for the user.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 provides an example of a component overview according to one or more embodiments of the present disclosure.

FIGS. 2 and 3 provide examples of a decision tree, or portion thereof, for use in accordance with one or more embodiments of the present disclosure.

FIG. 4, which comprises FIGS. 4A and 4B, provides a process flow for use in accordance with one or more embodiments of the present disclosure.

FIG. 5 illustrates some components that can be used in connection with one or more embodiments of the present disclosure.

FIG. 6 is a detailed block diagram illustrating an internal architecture of a computing device in accordance with one or more embodiments of the present disclosure.

### DETAILED DESCRIPTION

In general, the present disclosure includes a system, method and architecture of using user's social connection and information in web searching. A user's information, such as the user's geographic location, and social networking information, such as social connections with other users can be used in filtering and/or ranking search results, identifying relevant queries, and/or identifying content, such as news items, for presentation on a web page presented to the user.

Certain embodiments of the present disclosure will now be discussed with reference to the aforementioned figures, wherein like reference numerals refer to like components.

Embodiments of the present disclosure relate to information retrieval, such as that provided by a search system or search engine, and the information can relate to a topic, subject, a topic, aspect, etc. By way of a non-limiting example, for a given topic, there can be a set of queries that users may issue when seeking information about the topic, and there can be a set of documents which may satisfy users seeking information about the topic. A topic can be partitioned into aspects, which can describe different facets of the topic. A user may be interested in one or more of a topic's aspects. For a given user, embodiments of the present disclosure identify a probability of the user's interest in information, e.g., information related to a subject, topic, one or more aspects of the topic, etc. By way of a non-limiting example, the information that is sought can relate to an event, such as an earthquake, a violent storm, political election, etc.

Embodiments of the present disclosure can make use of properties, or attributes of the user. Properties of the user can include a users' demographic information (age, gender, etc), social parameters (circle of friends, acquaintances, and work associates), geographic parameters (location vis-a-vis a topic location), as well as other parameters (for example, time of day, exposure to different media, etc).

Embodiments of the present disclosure can also make use of geographic and social properties determined for the user in order to identify a probability of the user's interest in information. A physical distance, which can also be referred as the user's geographic detachment or geographic separation, is a user property which comprises a measure of physical distance between the user's geographic location and a geographic location associated with the information sought. The latter location can be an identified epicenter of an event for which the user is seeking information, for example.

Another property of the user involves a measure of the social affinity for the user, which can be determined in accordance with the users that are socially-connected to the user and are geographically close to the geographic location of the information sought, e.g., geographically close to a determined epicenter of an event about which information is sought. The property is referred to herein as a measure of the user's social affinity, social attachment, social distance and/or social separation. In accordance with one or more embodiments, the social affinity measure is determined to be the number of the users socially-connected to the user, e.g., friends, family co-workers, etc., within a threshold distance of a geographic location determined for the information sought, e.g., a topic, event, subject, aspect, etc.

In another embodiment, social affinity is determined by a physical distance of a socially-connected user, e.g., the physical distance determined to be the minimal of the physical distances determined for the socially-connected users. By way of a non-limiting example, a physical distance is determined for each of the socially-connected users, and the minimal, or least, of the physical distances determined for the socially-connected users is selected as the social affinity measure. By way of a further non-limiting example, the physical distance that is selected is the one determined for the socially-connected user that has a geographic location closest to the geographic location determined for the information sought. For each socially-connected user, the physical distance is determined using the geographic location determined for the information sought and the geographic location determined for the socially-connected user.

In accordance with one or more embodiments, the geographic separation and social affinity measures determined for the user can be used to identify the user's probability of interest in information sought, e.g., information about a topic, subject, event, aspects of a topic, etc.

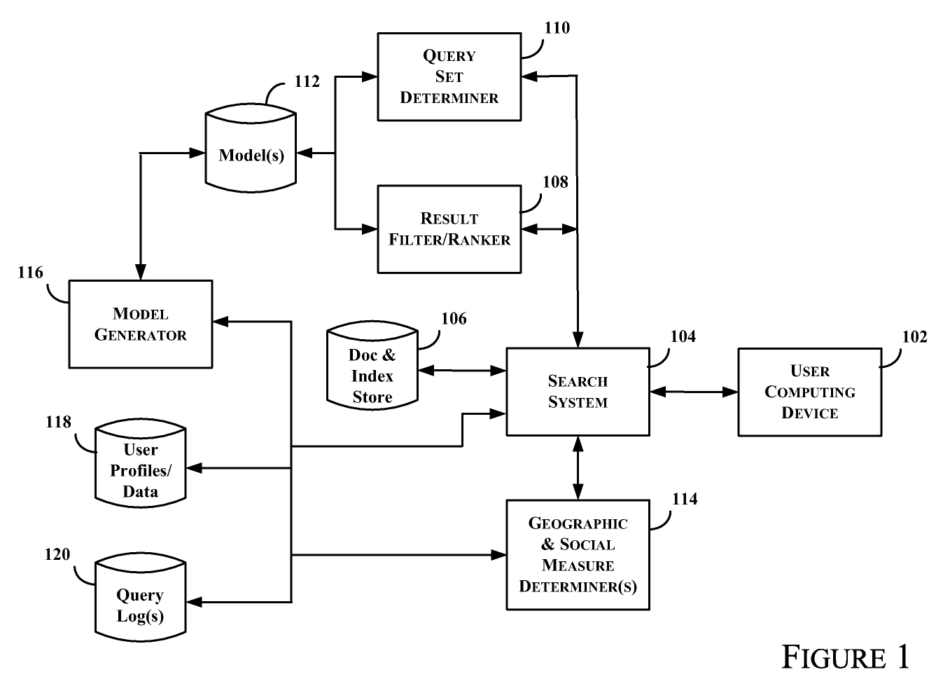

FIG. 1 provides an example of a component overview according to one or more embodiments of the present disclosure. Search system 104, which can comprise one or more server computers, or computing devices, can serve search results to user computing device 102 for a user. Additionally or alternatively, search system 104 can serve a set of alternate queries to user computing device 102. The search results and/or alternate query set can be served in response to a request from user computing device 102. The request can comprise a query input by the user using user computing device 102. Additionally or alternatively, the request can be generated as a result of the user's navigation to a web page, e.g., a home page associated with the user. Search system 104 can use document and index store 106 to generate a set of search results using one or more search terms and/or retrieve content for presentation at user computing device 102.

Also shown in the example of FIG. 1 are result filter/ranker 108, query set determiner 110, geographic and social measure determiner 114 and model generator 116. While these components and search system 104 are shown as separate components, it should be apparent that one or more of the components can be combined to form a single component, and that the functionality described with respect to each of the components can be performed by the single component. By way of one non-limiting example, search system 104 can comprise one or more of result filter/ranker 108, query set determiner 110, geographic and social measure determiner 114 and model generator 116. Additionally and while each component is shown as a single component, it should be apparent that the component can be divided into multiple components and that the functionality described in connection with the single component can be divided between the multiple components.

A geographic and social measure determiner 114 determines the geographic separation and social affinity measures for the user in connection with a request being processed by the search system 104. Additionally, the geographic and social measure determiner 114 can be used by model generator 116 in determining geographic separation and social affinity measures for users submitting queries stored in query log(s) 120, which measures can be used in generating one or more model(s) 112. The geographic separation and social affinity measures can be stored as part of the information stored for a query in query log(s) 120. A query can have an associated tuple of information, which includes its text, e.g., search terms, temporal information, e.g., time and date, and the geographic separation and social affinity measures of the user submitting the query.

Query set determiner 110 uses one or more of model(s) 112 to identify a set of queries using the user's geographic separation and social affinity measures. Result filter/ranker 108 uses one or more of model(s) 112 to rank and or filter, or cull, items in a set of search results.

In accordance with one or more embodiments, machine learning is used to build the one or more models 112, which can be used by query set determiner 110 to identify a query set, and/or by result filter/ranker 112 to filter and/or rank result items of a search result set. In accordance with one or more such embodiments, model(s) 112 are generated by model generator 116. Model generator 116 builds a model 112 using data from one or more query logs 120 and user profiles 118. By way of one non-limiting example, each user profile/data 118 includes information, or properties, of a user, e.g., unique user identifier (ID), address, gender, age, etc.

User profiles/data 118 can include attributes of the user, such as those described hereinabove, as well as any other information associated with the user. User profiles/data 118 can include social networking attributes, or information, such as data from social network applications, web sites, and other sources. Examples of social networking data include without limitation user contact data from messaging applications and sites, including without limitation electronic mail messages, text messages, instant messages, calendaring data, blogging and microblogging entries, web input, etc.

A user's list of contacts in an Instant Messenger (IM) application can be used as one non-limiting example of social networking information. The list of contacts can be used to determine the number of contacts each user has within the threshold distance of the geographic location determined for the information sought. A user's social affinity measure can be defined to be the number of contacts inside the radius of influence of each event, e.g., within the threshold distance.

The geographic separation measure can comprise a physical distance, or physical separation, which is determined using the user's geographic location and a geographic location associated with the information being sought. One non-limiting example of a geographic location of the information being sought is the epicenter of an event for which information is being sought. A larger value for the geographic separation measure can indicate a larger distance or separation of the user from an event, for example. The social affinity measure can comprise a measure of the user's social attachment or separation, e.g., from an event, topic or subject associated with the query, as measured by the number of other user to whom the user is socially connected, e.g., messaging contacts, that are determined to be local, e.g., within a threshold distance of the geographic location associated with the information being sought, e.g., the geographic location associated with the event, topic or subject of the query. A larger number for the social affinity measure indicates a smaller social separation.

By way of a non-limiting example, user profile/data 118 includes information, e.g., the user's zip-code given by users at the time of the user's registration, which can be used to identify a geographic location for the user. Alternatively and by way of a further non-limiting example, the geographic location can be determined using an Internet Protocol (IP) address of the user, a location specified by a global positioning system (GPS) enabled device, a location determined from a user's web surfing and/or searches, etc. As further illustration and without limitation, the user's geographic separation measure can be determined using the Haversine formula, which uses spherical trigonometry to determine a physical distance. It should be apparent that any method now known or later developed can be used to identify a user's geographic location and/or a physical distance.

In accordance with one or more embodiments, each query in query log(s) 120 has associated information, such as and without limitation search term(s), ID of user posting the query, temporal information including a time and/or date of the posting, information identifying each result item returned to the user in a set of search results, and information identifying the result items selected, or clicked on, by the user. Additionally and as is described in accordance with embodiments disclosed herein, the information can comprise the user's geographic separation and social affinity properties.

In accordance with one or more embodiments, one or more models 112 can be used by query set determiner 110 to identify comparable queries. By way of one non-limiting example, model(s) 112 can comprise a profile of queries from a training set of queries selected from query log(s) 120, and a profile associated with a recently-submitted query, a query contained in a search request received from user computing device 102, can be compared with the query profiles maintained in model(s) 112 to determine whether any of the queries represented in model(s) 112 are comparable to the recent query. By way of some non-limiting examples, a comparable query can be used to supplement the result items for the recently-submitted query and/or a comparable query can be displayed, e.g., in an indirect display, for selection and submission by the user.

By way of a non-limiting example, the query profiles from model(s) 112 and used by query set determiner 110 can be generated using query log(s) 120. The query log(s) 120 are parsed to identify relevant queries, queries relevant to an event, topic, aspect, subject, etc. A term matching scheme can be used as one alternative in identifying relevant queries. By way of a non-limiting example, in the case that the information sought is associated with an event of interest, a list of keywords can be generated, such as by identifying keywords drawn from multiple categories, such as and without limitation keywords associated with where the event took place, who was involved in the event, and what happened at the event. A list of excluded keywords can also be generated. The list of included keywords, and optionally the list of excluded keywords, is compared with the search terms used in a query to determine whether or not the query is relevant to the event. By way of a non-limiting example, a query can be considered to be relevant to the information sought if the query uses keywords from at least two categories and no keywords from the excluded keywords list.

Each of the queries identified as being relevant can be represented by information which can be stored as a profile of the query, for example. By way of some non-limiting examples, a query can be represented by its search terms, the geographic separation and social affinity measures of the user submitting the query, user ID, and temporal information, e.g., time and date the query was submitted by the user. By way of a further non-limiting example, in a case that a query occurs multiple times, a query can be represented by an average geographic separation measure and an average social affinity measure determined using a count of the number of times a query appears and aggregate geographic separation measure and social affinity measure. As one non-limiting example, for each query represented in the count, geographic separation and social affinity measures can be determined for the user submitting the query, the user's geographic separation and social affinity measures are each added to an aggregate of the measure, and the aggregate of each of the geographic separation and social affinity measures is divided by the count of the queries to yield the average.

In accordance with one or more embodiments, the recently-submitted query can also be represented by its attribute information, e.g., search terms, the geographic separation and social affinity measures of the user submitting the query, user ID, and temporal information, e.g., time and date the query was submitted by the user, etc. Query profiles of the recently-submitted query and queries from model(s) 112 are compared to identify whether any of the queries represented in model(s) 112 are comparable to the recently-submitted query. If one or more comparable queries are found, the comparable queries can be used to augment the search result items generated in connection with the recent query. Alternatively, the one or more comparable queries can be presented to the user as alternative queries, each of which being selectable by the user to initiate another search using the alternative query.

In accordance with one or more embodiments, one or more models 112 can be used by result filter/ranker 108 to filter and/or rank results based on, for example and without limitation, relevance. By way of one non-limiting example, a user's geographic separation and social affinity measures can be used to identify content, e.g., web pages, that are likely to be of interest to the user. In accordance with at least one embodiment, one or more of models 112 are trained and provide result filter/ranker 108 with a probability, or likelihood, that the user would be interested in a search result item from a set of search results resulting from the user's query. The items in the search result can be ordered based on their associated probabilities, and/or a number of the a search result item can be culled, or filtered from, the set of search results, before the search results are returned to the user computing device 102.

In accordance with one or more embodiments, different model(s) 112 can be generated for a value, or range of values, of the geographic separation measure and/or the social affinity measure. By way of one non-limiting example, the values for the geographic separation measure determined using a training set of queries, e.g., queries from query log(s) 120 determined to be relevant to the information sought, can be grouped into a number of groups and the values for the social affinity measure determined for the set of relevant queries form query logs(s) can be grouped into a number of groups. By way of a further non-limiting example, the groups of social affinity measure represent no local contacts, one local contact, and more than one local contact; and for each grouping of social affinity measure, a model 112 can be trained for each grouping of the geographic separation measure. In a case where there are five geographic separation measure groups and three social affinity measure groups, for example and without limitation, fifteen models 112 can be generated. The granularity of the groups and/or models can be varied and might be based on the data used to train the models, such as and without limitation the number of queries and/or the range of values for the geographic separation and social affinity measures determined from the data.

From query log(s) 120, a training data set comprising queries determined to be relevant to the information sought can be used to train a model 112 for use by result filter/ranker 108. For each query selected for the training data set, the items selected, or clicked on, by the user from the query's search result set can be considered to be of interest to the user. The training data, which can include for each query its search terms, the geographic separation and social affinity measures of the user submitting the query, user ID, the click information of the search result items, and temporal information, e.g., time and date the query was submitted by the user, can be used to build a model 112. By way of one non-limiting example, geographic separation measures of 10 kilometers or less can form one group and geographic separation measures that are greater than 10 kilometers can form another group; and social affinity measures can form a group for no local contacts, a group for one local contact, and a group for more than one local contact. For each pairing of a geographic separation measure group and a social affinity measure group, queries that have corresponding geographic separation and social affinity measures are selected and used to generate the model 112 for the pairing.

A model 112 can be selected for the recently-submitted query based on the geographic separation and social affinity measures determined for the user submitted the query. Result filter/ranker 108 can submit some or all of the information about the query, e.g., its search terms, the geographic separation and social affinity measures of the user submitting the query, user ID, the click information of the search result items, and temporal information, e.g., time and date the query was submitted by the user, to the model 112 to determine a probability of the user's interest in each of the search result items identified in the search results generated by search system 104. Result filter/ranker 108 can use the determined probabilities associated with each of the search result items identified by search system 104 to filter and/or rank the search result items.

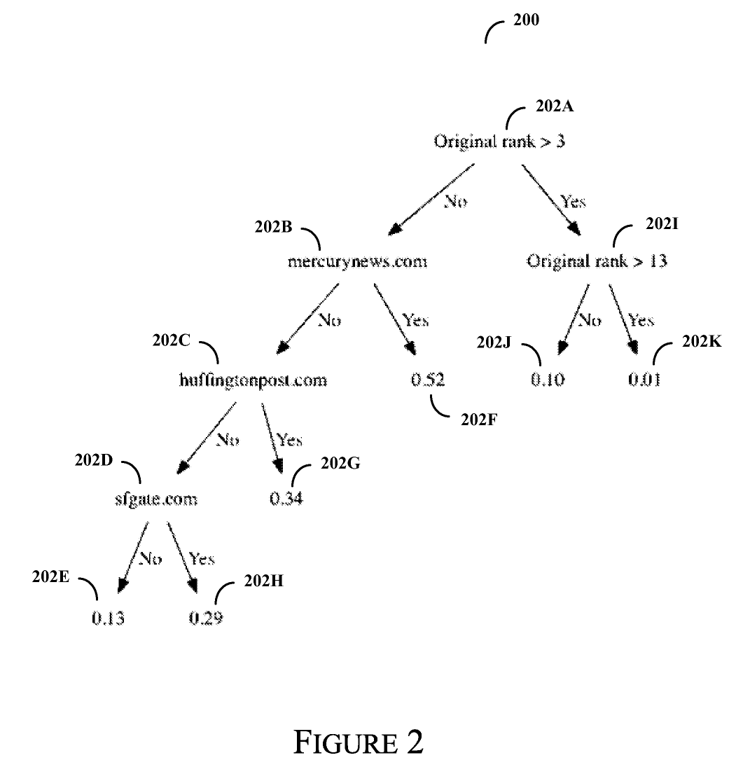

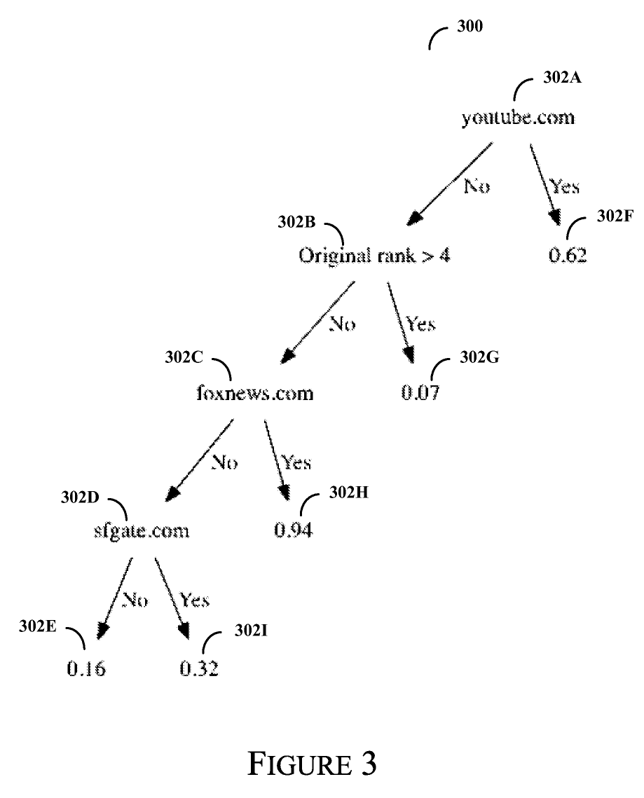

In accordance with at least one embodiment, a model 112 used by result filter/ranker 108 can be in the form of a decision tree. FIGS. 2 and 3 provide examples of decision trees, or portions thereof, for use in accordance with one or more embodiments of the present disclosure.

In the example shown in FIG. 2, decision tree 200, which can be a portion of a larger decision tree, includes nodes 202A-202K, each of which represents a decision point. Decision tree 200 can be traversed, prior to returning the search results to user computing device 102, for each of the items in the search results identified using the search criteria specified by the query. Search system 104 can provide the search results to result filter/ranker 108 with an initial, or original, ranking of the search result items, or result filter/ranker 108 can generate the initial ranking. At node 202A, a search item's original ranking is examined to determine whether the original rank is greater than three. Traversal continues to node 2021 in a case that the item's original rank is greater than three, or traversal continues to node 202B if not. At node 2021, if the original rank is greater than thirteen, decision tree 200 is traversed to node 202K, which specifies a probability of 0.01 that the search result item will be of interest to the user. If the search item's original ranking is greater than three but less than or equal to thirteen, traversal reaches node 202J, which indicates a probability of 0.10 that the item will be of interest to the user.

Each search item typically refers to an item of content, e.g., a web page, document, multimedia content, etc. The search result item can include a reference, such as a universal resource locator (URL), to the item of content. The reference can include a reference to a domain, e.g., a domain for the content. In the example decision tree 200 shown in FIG. 2, nodes 202B-202D examine the domain associated with the search item, and assign a probability of interest to the user based whether the domain associated with the search result item matches the domain associated with the node.

FIG. 3 provides another example of a decision tree, or portion thereof, which can be used in accordance with one or more embodiments of the present disclosure. Decision tree 300 includes nodes 302A-302I. In the example shown in decision tree 300, traversal of nodes 302B-302I is based on a determination whether or not the domain associated with the search item matches the one specified at node 302A. If so, the search result item's probability of interest to the user is specified to be 0.62. Otherwise, the original ranking of the search item is examined to determine whether traversal continues to node 302C or 302G. If node 302G is reached, a determination is made whether the domain matches the domain specified by the node, and node 302D is reached if the domain specified at node 302C does not match the domain associated with the search item.

In accordance with one or more embodiments, each search item can be assigned a probability of interest to the user using one or more decision trees, or other forms of, model(s) 112. Result filter/ranker 108 can modify the original ranking using the search items' probabilities of interest. By way of one non-limiting example, the probabilities of interest can be used as a weighting, such that each search item's original ranking is modified by multiplying it by the search item's probabilities of interest. By way of another non-limiting example, the search items can be ranked based on each item's probability of interest to the user. Result filter/ranker 108 can filter one or more search items from the search results using the new ranking of the search items.

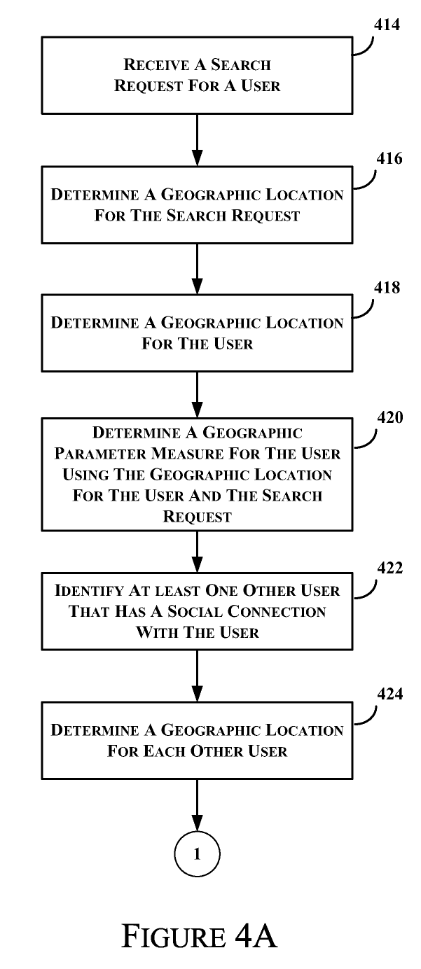

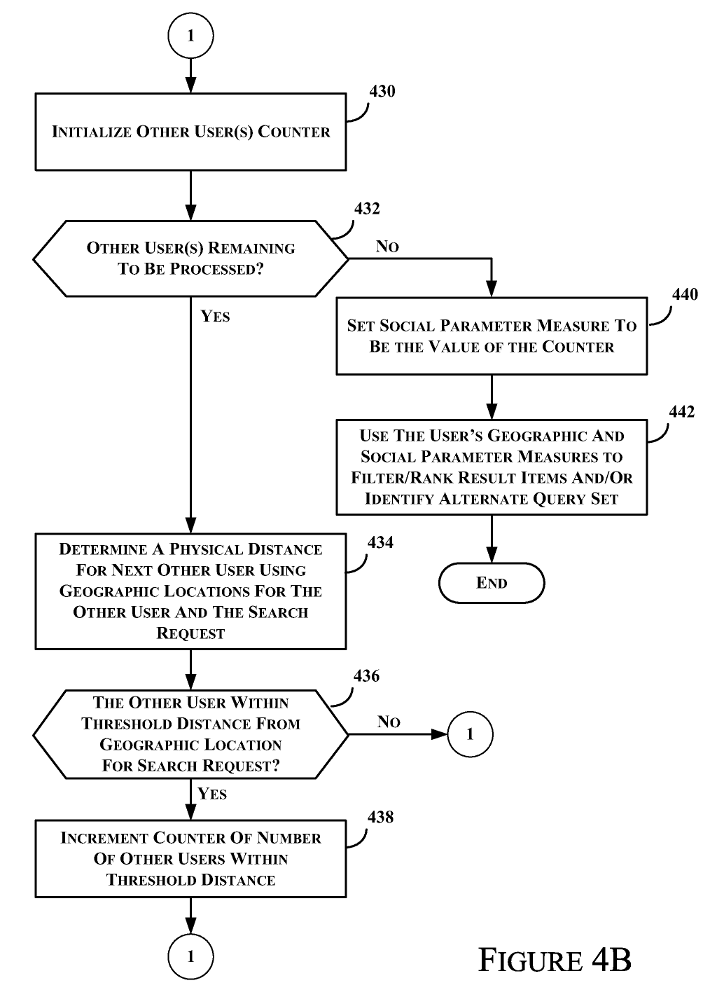

FIG. 4, which comprises FIGS. 4A and 4B, provides a process flow for use in accordance with one or more embodiments of the present disclosure.

At step 414, a search request is received for a user. At step 416, a geographic location is determined for the search request, e.g., a geographic location for the information being sought, or the information need, in connection with the search request. By way of some non-limiting examples, the geographic location for the search request can be specified as a system, or configurable, setting, selected from a number of settings, specified by a user or other entity, identified using the location of the users submitting the request, and/or by extracting geographic location information, e.g., an indication of one or more of a town, city, state, country, etc., included in the information sought by the search request, e.g., the information retrieved using the search criteria included in the request, or included in the search request. It should be apparent that any method now known or later developed can be used to determine a geographic location in connection with the search request.

At step 418, a geographic location is determined for the user. As discussed herein, any method now known or later can be used to determine a geographic location for the user. At step 420, the geographic separation measure is determined to be a distance between the geographic location determined for the search request and the geographic location determined for the user.

At step 422, the user's social networking information is examined to identify one or more other users having a social connection with the user. At step 424, the geographic location for each of these other users is determined using, for example, a mechanism used to identify the user's geographic location.

Referring to step 430 of FIG. 4B, a counter is initialized, e.g., set to zero. The counter indicates a number of the other users that are socially-connected with the user and are within a threshold distance of the user. The number indicated by the counter can be used as the social affinity measure, e.g., a measure of the user's social affinity, social attachment, social separation, social detachment, etc.

At step 432, a determination is made whether any of the other users remain to be processed. If so, processing continues at step 434 to determine a geographic separation measure for the next one of the other users. As with the user, the physical distance of the socially-connected user from the location determined for the search request. At step 436, a determination is made whether or not the other user's physical distance is within the threshold distance from the geographic location determined for the search request.

The threshold distance used in accordance with one or more embodiments can be a system, or configuration setting, selected from a number of settings, specified by a user or other entity, identified using the location of the users submitting the request, and/or by setting the threshold to include locations identified by extracting geographic location information, e.g., an indication of one or more of a town, city, state, country, etc., included in the information sought by the search request, e.g., the information retrieved using the search criteria included in the request, or included in the search request. It should be apparent that any method now known or later developed can be used to determine a threshold distance. The threshold distance can be expressed as a radius that can be used to determine a boundary encircling the geographic location determined for the search request.

If it is determined, at step 436, that the other user is within the threshold distance, processing continues at step 438 to increment the counter of the number of the other users within the threshold distance. Processing continues at step 432 to process any remaining other users. If it is determined at step 432 that there are no more other users to be processed, processing continues at step 440 to set the user's social affinity measure to be equal to the value of the counter.

At step 442, the user's geographic separation and social affinity measures are used to generate a response to the received search request. The response can include a set of search results ranked and/or filtered by result filter/ranker 108 in accordance with the probability of the user's interest in each of the result items identified in a search performed by search system 104. The search performed by search system 104 can include a search using one or more of the alternative queries identified by query set determiner 110 in accordance with the user's geographic separation and social affinity measures. In such a case, the set of search results transmitted to user computing device 102 can include one or more result items identified using the one or more alternate queries. The response can include the set of alternate queries identified by query set determiner 110 in accordance with the user's geographic separation and social affinity measures. The set of alternate queries can be transmitted in addition to the set of search results.

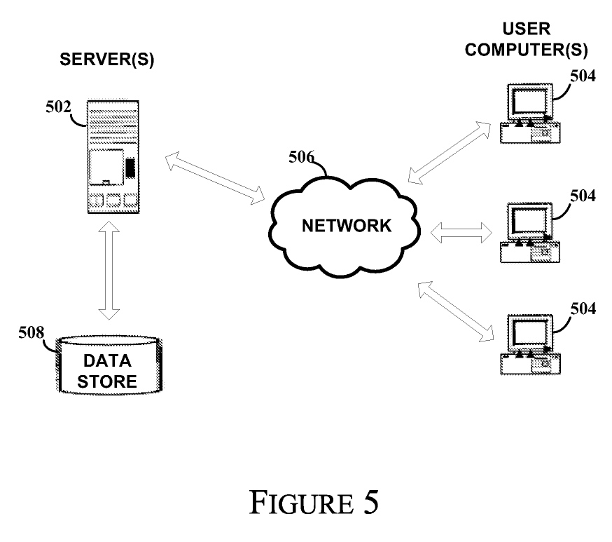

FIG. 5 illustrates some components that can be used in connection with one or more embodiments of the present disclosure. In accordance with one or more embodiments of the present disclosure, one or more computing devices, e.g., one or more servers, user devices 102 or other computing device, are configured to comprise functionality described herein. For example, a computing device 502 can be configured to execute program code, instructions, etc. to provide functionality in accordance with one or more embodiments of the present disclosure. One or more of computing device 502 can be configured to provide functionality of search system, or engine, 104, geographic and social measure determiner 114, query set determiner 110, result filter/ranker 108, and/or model generator 116, for example. Computing device 502 can be associated with one or more of data store 508. Data store 508 can comprise, among other things, document and index storage 106, model(s) 112, user profiles 118 and/or query log(s) 120, for example. Additionally, data store 508 can store program code to configure a server 502 to execute to provide functionality described herein. Computing device 502 can serve content to user computing devices 504 via a browser application executing at user computing device 504 via a network 506.

The user computing device 504, which can be user computing device 102, can be any computing device, including without limitation a personal computer, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device such as server 502 and the user computing device 504 can include one or more processors, memory, a removable media reader, network interface, display and interface, and one or more input devices, e.g., keyboard, keypad, mouse, etc. and input device interface, for example. One skilled in the art will recognize that server 502 and user computing device 504 may be configured in many different ways and implemented using many different combinations of hardware, software, or firmware.

In accordance with one or more embodiments, a computing device 502 can make a user interface available to a user computing device 504 via the network 506. The user interface made available to the user computing device 504 can include content items, or identifiers (e.g., URLs) selected for the user interface in accordance with one or more embodiments of the present invention. In accordance with one or more embodiments, computing device 502 makes a user interface available to a user computing device 504 by communicating a definition of the user interface to the user computing device 504 via the network 506. The user interface definition can be specified using any of a number of languages, including without limitation a markup language such as Hypertext Markup Language, scripts, applets and the like. The user interface definition can be processed by an application executing on the user computing device 504, such as a browser application, to output the user interface on a display coupled, e.g., a display directly or indirectly connected, to the user computing device 504.

In an embodiment the network 506 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

It should be apparent that embodiments of the present disclosure can be implemented in a client-server environment such as that shown in FIG. 5. Alternatively, embodiments of the present disclosure can be implemented other environments, e.g., a peer-to-peer environment as one non-limiting example.

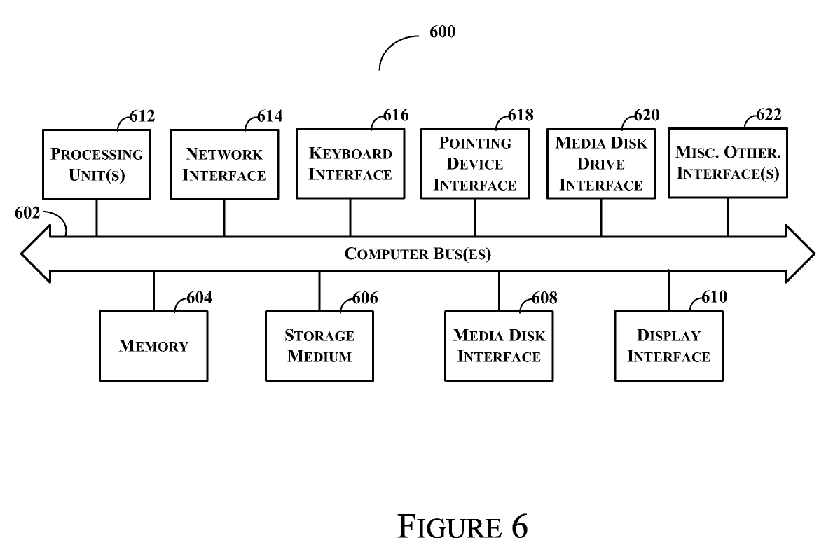

FIG. 6 is a detailed block diagram illustrating an internal architecture of a computing device, e.g., a computing device such as server 502 or user computing device 504, in accordance with one or more embodiments of the present disclosure. As shown in FIG. 6, internal architecture 600 includes one or more processing units, processors, or processing cores, (also referred to herein as CPUs) 612, which interface with at least one computer bus 602. Also interfacing with computer bus 602 are computer-readable medium, or media, 606, network interface 614, memory 604, e.g., random access memory (RAM), run-time transient memory, read only memory (ROM), etc., media disk drive interface 620 as an interface for a drive that can read and/or write to media including removable media such as floppy, CD-ROM, DVD, etc. media, display interface 610 as interface for a monitor or other display device, keyboard interface 616 as interface for a keyboard, pointing device interface 618 as an interface for a mouse or other pointing device, and miscellaneous other interfaces not shown individually, such as parallel and serial port interfaces, a universal serial bus (USB) interface, and the like.

Memory 604 interfaces with computer bus 602 so as to provide information stored in memory 604 to CPU 612 during execution of software programs such as an operating system, application programs, device drivers, and software modules that comprise program code, and/or computer-executable process steps, incorporating functionality described herein, e.g., one or more of process flows described herein. CPU 612 first loads computer-executable process steps from storage, e.g., memory 604, computer-readable storage medium/media 606, removable media drive, and/or other storage device. CPU 612 can then execute the stored process steps in order to execute the loaded computer-executable process steps. Stored data, e.g., data stored by a storage device, can be accessed by CPU 612 during the execution of computer-executable process steps.

Persistent storage, e.g., medium/media 606, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
receiving, via at least one processor, a search request for a user;
determining, via the at least one processor, a geographic separation measure for the user using a geographic location for the information sought in connection with the search request and a geographic location for the user;
determining, via the at least one processor, a social affinity measure for the user, the social affinity measure being determined from the geographic location of each of one or more other users identified as having a social connection with the user and being within a threshold distance of the geographic location for the information sought; and
generating, via the at least one processor, a response to the search request using the geographic separation and social affinity measures determined for the user.

2. The method of claim 1, the determining a social affinity measure for the user further comprising:
determining, via the at least one processor, the geographic location for each of the one or more other users;
determining, for each of the one or more other users via the at least one processor, a physical distance of the other user from the geographic location for the information sought;
determining, for each of the one or more other users via the at least one processor, whether the other user's physical distance is within a threshold distance from the geographic location for the information sought;
determining, via the at least one processor, the user's social affinity measure to be a number of the other users having a physical distance determined to be within the threshold distance from the geographic location for the information sought.

3. The method of claim 1, the generating a response further comprising:
generating, via the at least one processor, search results using a query received with the search request;
determining, via the at least one processor, at least one alternate query for the search request using the geographic separation measure and social affinity measure determined for the user; and
transmitting, to the user's computing device via the at least one processor, the search results and the at least one alternate query.

4. The method of claim 3, the generating search results further comprising:
determining, for each result item of a plurality of result items in the search results via the at least one processor, a probability of the user's interest in the result item using the user's geographic separation measure and social affinity measure; and
ranking, via the at least one processor, the plurality of result items in accordance with each result item's probability of the user's interest.

5. The method of claim 3, the generating search results further comprising:
determining, for each result item of a plurality of result items in the search results via the at least one processor, a probability of the user's interest in the result item using the user's geographic separation measure and social affinity measure; and
filtering, via the at least one processor, the search results in accordance with each result item's probability of the user's interest.

6. The method of claim 1, the generating a response further comprising:
determining, via the at least one processor, one or more alternate queries for the search request using the user's geographic separation measure and social affinity measure;
generating, via the at least one processor, search results using a query received with the search request and at least one of the alternate queries; and
transmitting, to the user's computing device via the at least one processor, the search results.

7. The method of claim 6, the generating search results further comprising:
determining, for each result item of a plurality of result items in the search results via the at least one processor, a probability of the user's interest in the result item using the user's geographic separation measure and social affinity measure; and
ranking, via the at least one processor, the plurality of result items in accordance with each result item's probability of the user's interest.

8. The method of claim 6, the generating search results further comprising:
determining, for each result item of a plurality of result items in the search results via the at least one processor, a probability of the user's interest in the result item using the user's geographic separation measure and social affinity measure; and
filtering, via the at least one processor, the search results in accordance with each result item's probability of the user's interest.

9. A system comprising:
at least one computing device comprising one or more processors to execute and memory to store instructions to:
receive a search request for a user;
determine a geographic separation measure for the user using a geographic location for the information sought in connection with the search request and a geographic location for the user;
determine a social affinity measure for the user, the social affinity measure being determined from the geographic location of each of one or more other users identified as having a social connection with the user and being within a threshold distance of the geographic location for the information sought; and
generate a response to the search request using the geographic separation and social affinity measures determined for the user.

10. The system of claim 9, the instructions to determine a social affinity measure for the user further comprising instructions to:
determine the geographic location for each of the one or more other users;
determine, for each of the one or more other users, a physical distance of the other user from the geographic location for the information sought;
determine, for each of the one or more other users, whether the other user's physical distance is within a threshold distance from the geographic location for the information sought;
determine the user's social affinity measure to be a number of the other users having a physical distance determined to be within the threshold distance from the geographic location for the information sought.

11. The system of claim 9, the instructions to generate a response further comprising instructions to:
generate search results using a query received with the search request;
determine at least one alternate query for the search request using the geographic separation measure and social affinity measure determined for the user; and
transmit to the user's computing device, the search results and the at least one alternate query.

12. The system of claim 12, the instructions to generate search results further comprising instructions to:
determine, for each result item of a plurality of result items in the search results, a probability of the user's interest in the result item using the user's geographic separation measure and social affinity measure; and
rank the plurality of result items in accordance with each result item's probability of the user's interest.

13. The system of claim 12, the instructions to generate search results further comprising instructions to:
determine, for each result item of a plurality of result items in the search results, a probability of the user's interest in the result item using the user's geographic separation measure and social affinity measure; and
filter the search results in accordance with each result item's probability of the user's interest.

14. The system of claim 9, the instructions to generate a response further comprising instructions to:
determine one or more alternate queries for the search request using the user's geographic separation measure and social affinity measure;
generate search results using a query received with the search request and at least one of the alternate queries; and
transmit, to the user's computing device, the search results.

15. The system of claim 15, the instructions to generate search results further comprising instructions to:
determine, for each result item of a plurality of result items in the search results, a probability of the user's interest in the result item using the user's geographic separation measure and social affinity measure; and
rank the plurality of result items in accordance with each result item's probability of the user's interest.

16. The system of claim 15, the instructions to generate search results further comprising instructions to:
determine, for each result item of a plurality of result items in the search results, a probability of the user's interest in the result item using the user's geographic separation measure and social affinity measure; and
filter the search results in accordance with each result item's probability of the user's interest.

17. A computer readable non-transitory storage medium for tangibly storing thereon computer readable instructions that when executed cause at least one processor to:
receive a search request for a user;
determine a geographic separation measure for the user using a geographic location for the information sought in connection with the search request and a geographic location for the user;
determine a social affinity measure for the user, the social affinity measure being determined from the geographic location of each of one or more other users identified as having a social connection with the user and being within a threshold distance of the geographic location for the information sought; and
generate a response to the search request using the geographic separation and social affinity measures determined for the user.

18. The computer readable non-transitory storage medium of claim 17, the computer readable instructions that when executed further cause at least one processor to determine a social affinity measure for the user further comprising computer readable instructions that when executed further cause at least one processor to:
determine the geographic location for each of the one or more other users;
determine, for each of the one or more other users, a physical distance of the other user from the geographic location for the information sought;
determine, for each of the one or more other users, whether the other user's physical distance is within a threshold distance from the geographic location for the information sought;
determine the user's social affinity measure to be a number of the other users having a physical distance determined to be within the threshold distance from the geographic location for the information sought.

19. The computer readable non-transitory storage medium of claim 17, the computer readable instructions that when executed further cause at least one processor to generate a response further comprising computer readable instructions that when executed further cause at least one processor to:
generate search results using a query received with the search request;
determine at least one alternate query for the search request using the geographic separation measure and social affinity measure determined for the user; and
transmit to the user's computing device, the search results and the at least one alternate query.

20. The computer readable non-transitory storage medium of claim 19, the computer readable instructions that when executed further cause at least one processor to generate search results further comprising computer readable instructions that when executed further cause at least one processor to:
determine, for each result item of a plurality of result items in the search results, a probability of the user's interest in the result item using the user's geographic separation measure and social affinity measure; and
rank the plurality of result items in accordance with each result item's probability of the user's interest.

21. The computer readable non-transitory storage medium of claim 19, the computer readable instructions that when executed further cause at least one processor to generate search results further comprising computer readable instructions that when executed further cause at least one processor to:
determine, for each result item of a plurality of result items in the search results, a probability of the user's interest in the result item using the user's geographic separation measure and social affinity measure; and
filter the search results in accordance with each result item's probability of the user's interest.

22. The computer readable non-transitory storage medium of claim 17, the computer readable instructions that when executed further cause at least one processor to generate a response further comprising computer readable instructions that when executed further cause at least one processor to:
determine one or more alternate queries for the search request using the user's geographic separation measure and social affinity measure;
generate search results using a query received with the search request and at least one of the alternate queries; and
transmit, to the user's computing device, the search results.

23. The computer readable non-transitory storage medium of claim 22, the computer readable instructions that when executed further cause at least one processor to generate search results further comprising computer readable instructions that when executed further cause at least one processor to:
determine, for each result item of a plurality of result items in the search results, a probability of the user's interest in the result item using the user's geographic separation measure and social affinity measure; and
rank the plurality of result items in accordance with each result item's probability of the user's interest.

24. The computer readable non-transitory storage medium of claim 22, the computer readable instructions that when executed further cause at least one processor to generate search results further comprising computer readable instructions that when executed further cause at least one processor to:
determine, for each result item of a plurality of result items in the search results, a probability of the user's interest in the result item using the user's geographic separation measure and social affinity measure; and
filter the search results in accordance with each result item's probability of the user's interest.
